(19) United States
(12) Patent Application Publication
(10) Pub. No.: US 2025/0087900 A1
(43) Pub. Date: Mar. 13, 2025

(54) ANTENNA DEVICE

(71) Applicant: YOKOWO CO., LTD., Tokyo (JP)

(72) Inventors: Satoshi IWASAKI, Tomioka-shi, Gunma (JP); Noritaka TERASHITA, Tomioka-shi, Gunma (JP)

(73) Assignee: YOKOWO CO., LTD., Tokyo (JP)

(21) Appl. No.: 18/727,941

(22) PCT Filed: Jan. 12, 2023
(86) PCT No.: PCT/JP2023/000557

§ 371 Date: Jul. 10, 2024

(30) Foreign Application Priority Data
Jan. 28, 2022 (JP) 2022-011482

(51) Int. Cl. H01Q 21/06; H01Q 1/32; H01Q 9/04; H01Q 19/00

(52) U.S. Cl. CPC H01Q 21/065; H01Q 1/3275; H01Q 9/0407; H01Q 19/005

(57) ABSTRACT

An antenna device comprises an antenna base, an antenna case forming an accommodation space together with the antenna base, and a first antenna element accommodated in the accommodation space. The first antenna element is disposed along a direction intersecting a longitudinal direction of the antenna base.

### TECHNICAL FIELD

The present invention relates to an antenna device.

### BACKGROUND ART

Requirements for a fifth generation mobile communication system (5G) include a high communication speed, a large capacity, and high reliability. In recent years, for example, as described in Patent Document 1, use of multiple-input and multiple-output (MIMO) has been examined to cope with such requirements.

### RELATED DOCUMENT

### Patent Document

Patent Document 1: U.S. Unexamined Patent Publication No. 2015/0071137

### SUMMARY OF THE INVENTION

### Technical Problem

In the antenna device using MIMO, a plurality of antenna elements are installed on an antenna base. For example, an antenna element such as a cellular antenna described in Patent Document 1 disposed along a longitudinal direction of an antenna base leads to an increase in the size of an antenna device in the longitudinal direction of the antenna base.

An example of an object of the present invention is to reduce the size of an antenna device. Other objects of the present invention will become apparent from the description herein.

### Solution to Problem

An aspect of the present invention is an antenna device comprising:
an antenna base,
an antenna case forming an accommodation space together with the antenna base, and
a first antenna element accommodated in the accommodation space,
in which the first antenna element is disposed along a direction intersecting a longitudinal direction of the antenna base.

According to the above aspect of the present invention, the size of an antenna device can be reduced.

### BRIEF DESCRIPTION OF THE DRAWINGS

FIG. 1 A perspective view of an antenna device according to Embodiment 1.

FIG. 2 A graph showing the isolation value between a second antenna element and a third antenna element in an antenna device according to Example and the isolation value between a second antenna element and a third antenna element in an antenna device according to Comparative Example 1.

FIG. 3 A graph showing a directivity gain with respect to an azimuth in the antenna device according to Example, a directivity gain with respect to an azimuth in an antenna device according to Comparative Example 2, and a directivity with respect to an azimuth in an antenna device according to Comparative Example 3.

FIG. 4 A perspective view of an antenna device according to Embodiment 2.

FIG. 5 A perspective view of an antenna device according to Embodiment 3.

FIG. 6 A perspective view of an antenna device according to Embodiment 4.

FIG. 7 A perspective view of an antenna device according to a variant.

### DESCRIPTION OF EMBODIMENTS

Hereinafter, embodiments and variants of the present invention will be described with reference to the drawings. In all drawings, the similar constituent components are denoted by the similar reference signs, and detailed description thereof will not be repeated.

In the present specification, ordinal numbers, such as “first”, “second”, and “third”, are attached only for distinguishing components to which the same names are attached unless otherwise specified, and do not mean particular features (for example, an order or a degree of importance) of the components.

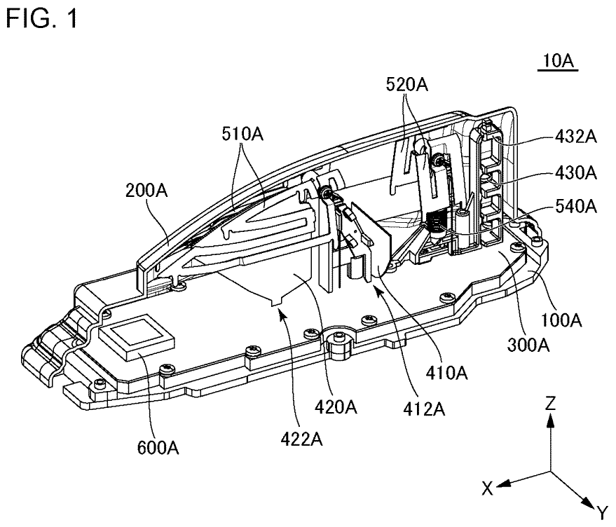

FIG. 1 is a perspective view of an antenna device 10A according to Embodiment 1. In FIG. 1, for the sake of description, the left half of an antenna case 200A, which will be described later, is removed.

In FIG. 1, an arrow indicating a first direction X, a second direction Y, or a third direction Z indicates that a direction from a base end toward a tip of the arrow is a positive direction of a direction indicated by the arrow and a direction from the tip toward the base end of the arrow is a negative direction of the direction indicated by the arrow.

In FIG. 1, the first direction X is a direction parallel to a front and rear direction of the antenna device 10A. Specifically, a positive direction of the first direction X is a direction from a rear side of the antenna device 10A to a front side of the antenna device 10A. A negative direction of the first direction X is a direction from the front side to the rear side of the antenna device 10A. The second direction Y is orthogonal to the first direction X. The second direction Y is a direction parallel to a left and right direction of the antenna device 10A. Specifically, a positive direction of the second direction Y is a direction from a right side to a left side of the antenna device 10A. A negative direction of the second direction Y is a direction from the left side to the right side of the antenna device 10A. The third direction Z is orthogonal to both the first direction X and the second direction Y. The third direction Z is a direction parallel to an up and down direction of the antenna device 10A. Specifically, a positive direction of the third direction Z is a direction from a lower side to an upper side of the antenna device 10A. A negative direction of the third direction z is a direction from the upper side to the lower side of the antenna device 10A.

The antenna device 10A according to Embodiment 1 includes an antenna base 100A, the antenna case 200A, a substrate 300A, a first antenna element 410A, a second antenna element 420A, a third antenna element 430A, an antenna holder 432A, a pair of first capacitive loading elements 510A, a pair of second capacitive loading elements 520A, a coil element 540A, and a patch antenna 600A. The antenna device 10A is installed on a vehicle, for example. The object on which the antenna device 10A is installed, however, is not limited to a vehicle.

The antenna base 100A is made of, for example, at least one of metal and resin. The length of the antenna base 100A in the first direction X is greater than the width of the antenna base 100A in the second direction Y. Thus, a longitudinal direction of the antenna base 100A is substantially parallel to the first direction X. A transverse direction of the antenna base 100A is substantially parallel to the second direction Y.

The antenna case 200A covers the antenna base 100A from above. The antenna case 200A forms an accommodation space together with the antenna base 100A. The accommodation space accommodates the substrate 300A, the first antenna element 410A, the second antenna element 420A, the third antenna element 430A, the antenna holder 432A, the first capacitive loading elements 510A, the second capacitive loading elements 520A, the coil element 540A, and the patch antenna 600A.

The substrate 300A is a printed circuit board (PCB), for example. The substrate 300A is disposed on an upper surface side of the antenna base 100A. Specifically, in Embodiment 1, the substrate 300A is screwed to an upper surface of the antenna base 100A.

The first antenna element 410A is an antenna to perform at least one of transmission and reception of radio waves. The first antenna element 410A is, for example, a telephone (TEL) antenna. The first antenna element 410A, however, may be at least one of a Wi-Fi (registered trademark) antenna, a Bluetooth (registered trademark) antenna, a Vehicle-to-everything (V2X) antenna, and a keyless entry antenna.

The first antenna element 410A is disposed on an upper surface side of the substrate 300A. In Embodiment 1, the first antenna element 410A is made of sheet metal. The first antenna element 410A includes a first base end portion 412A. The first base end portion 412A is provided at a lower end of the first antenna element 410A. The first base end portion 412A is electrically connected to the substrate 300A. The first base end portion 412A includes a feeding point of the first antenna element 410A. The first antenna element 410A may be composed of a conductive pattern provided on a substrate such as a PCB.

The first antenna element 410A is disposed along a direction intersecting the longitudinal direction of the antenna base 100A as seen in the third direction Z. Specifically, the first antenna element 410A is disposed substantially parallel to the second direction Y as seen in the third direction Z.

The first antenna element 410A has a portion to operate as a self-similar antenna or an antenna equivalent to the self-similar antenna as seen in the first direction X. Accordingly, the first antenna element 410A can operate in wideband and is suitable for a TEL antenna. The “self-similar antenna” is, for example, an antenna such as a bow tie antenna and a biconical antenna, having a similar shape at varied scales (size ratios). Specifically, as seen in the first direction X, the width of the first antenna element 410A in the second direction Y increases from the first base end portion 412A toward an upper end of the first antenna element 410A. For this reason, as seen in the first direction X, the width in the second direction Y of the first antenna element 410A on a distal side with respect the first base end portion 412A is greater than the width in the second direction Y of the first antenna element 410A on a proximal side with respect to the first base end portion 412A. In Embodiment 1, the first antenna element 410A is disposed above a ground plate such as a roof of a vehicle on which the antenna device 10A is installed.

In Embodiment 1, the length of the first antenna element 410A in the first direction X can be reduced in comparison with a case where the first antenna element 410A is disposed along the longitudinal direction of the antenna base 100A as seen in the third direction Z. For this reason, the size of the antenna device 10A in the longitudinal direction of the antenna base 100A can be reduced in comparison with the above-described case.

The second antenna element 420A is an antenna to perform at least one of transmission and reception of radio waves. The second antenna element 420A is, for example, a TEL antenna. The second antenna element 420A, however, may be at least one of a Wi-Fi (registered trademark) antenna, a Bluetooth (registered trademark) antenna, a V2X antenna, and a keyless entry antenna. When the first antenna element 410A, the second antenna element 420A, and the third antenna element 430A are TEL antennas, MIMO can be realized in Embodiment 1 by using the second antenna element 420A together with at least one of the first antenna element 410A and the third antenna element 430A.

The second antenna element 420A is disposed on a positive-direction side in the first direction X with respect to the first antenna element 410A. The second antenna element 420A is disposed on the upper surface side of the substrate 300A. In Embodiment 1, the second antenna element 420A is made of sheet metal. The second antenna element 420A includes a second base end portion 422A. The second base end portion 422A is provided at a lower end of the second antenna element 420A. The second base end portion 422A is electrically connected to the substrate 300A. The second base end portion 422A includes a feeding point of the second antenna element 420A. The second antenna element 420A may be composed of a conductive pattern provided on a substrate such as a PCB.

The second antenna element 420A is disposed along the longitudinal direction of the antenna base 100A. Specifically, in Embodiment 1, the second antenna element 420A is disposed to be substantially parallel to the first direction X as seen in the third direction Z. Accordingly, the first antenna element 410A and the second antenna element 420A are disposed along directions different from each other as seen in the third direction Z.

The second antenna element 420A has a portion to operate as a self-similar antenna or an antenna equivalent to the self-similar antenna as seen in the second direction Y. Accordingly, the second antenna element 420A can operate in wideband.

In Embodiment 1, the length of the space necessary between the first antenna element 410A and the second antenna element 420A in the first direction X can be reduced in comparison with a case where both the first antenna element 410A and the second antenna element 420A are disposed along the longitudinal direction of the antenna base 100A as seen in the third direction Z. For this reason, deterioration of isolation between the first antenna element 410A and the second antenna element 420A can be reduced in comparison with the above-described case even if the length of the antenna device 10A in the first direction X is decreased. For this reason, the first antenna element 410A and the second antenna element 420A can obtain a desired gain in comparison with the above-described case even if the length of the antenna device 10A in the first direction X is decreased.

In Embodiment 1, a direction of a traveling wave of the first antenna element 410A and a direction of a traveling wave of the second antenna element 420A are 90 degrees offset from each other in comparison with a case where both the first antenna element 410A and the second antenna element 420A are disposed along the longitudinal direction of the antenna base 100A as seen in the third direction Z. For this reason, deterioration of isolation between the first antenna element 410A and the second antenna element 420A at a high frequency band can be reduced in comparison with the above-described case.

In Embodiment 1, the height of the first antenna element 410A in the third direction Z is less than the height of the second antenna element 420A in the third direction Z. Accordingly, the second antenna element 420A can operate also at a lower frequency band than the first antenna element 410A. Furthermore, interference in low frequency band between the first antenna element 410A and the second antenna element 420A can be reduced and deterioration of isolation between the first antenna element 410A and the second antenna element 420A can be reduced in comparison with a case where the height of the first antenna element 410A in the third direction Z is equal to the height of the second antenna element 420A in the third direction Z.

The third antenna element 430A is an antenna to perform at least one of transmission and reception of radio waves. In Embodiment 1, the third antenna element 430A is, for example, a V2X antenna. The third antenna element 430A, however, may be at least one of a TEL antenna, a Wi-Fi (registered trademark) antenna, a Bluetooth (registered trademark) antenna, and a keyless entry antenna. When the first antenna element 410A, the second antenna element 420A, and the third antenna element 430A are TEL antennas, MIMO can be realized in Embodiment 1 by using the third antenna element 430A together with at least one of the first antenna element 410A and the second antenna element 420A.

The third antenna element 430A is disposed on an upper surface side of the substrate 300A. Specifically, the third antenna element 430A is held by the antenna holder 432A in a direction approximately parallel to the third direction Z with respect to the substrate 300A. The third antenna element 430A is, for example, a collinear array antenna.

The third antenna element 430A is disposed on a negative-direction side in the first direction X with respect to the first antenna element 410A as seen in the third direction Z. The third antenna element 430A is disposed on the negative-direction side in the first direction X with respect to the second capacitive loading elements 520A and the coil element 540A as seen in the third direction z.

In Embodiment 1, as described above, the first antenna element 410A is disposed along a direction intersecting the longitudinal direction of the antenna base 100A as seen in the third direction Z. For this reason, the first antenna element 410A can operate as a reflector to reflect radio waves radiated from the third antenna element 430A. For example, there is a case where relatively high directivity in a direction perpendicular to the third direction Z is required for the third antenna element 430A, such as a case where the third antenna element 430A is a V2X antenna. In this case, the rearward directivity of the third antenna element 430A can be enhanced in Embodiment 1 in comparison with a case where the first antenna element 410A is not provided or a case where the first antenna element 410A is disposed along the longitudinal direction of the antenna base 100A as seen in the third direction Z.

In Embodiment 1, a parasitic element for enhancement of the rearward directivity of the third antenna element 430A need not be provided near the pair of second capacitive loading elements 520A. For this reason, the cost of the antenna device 10A can be reduced by the parasitic element in comparison with a case where the parasitic element is provided. The size of the antenna device 10A in the first direction X can be reduced in comparison with a case where the parasitic element is provided. Furthermore, the influence of the parasitic element on the characteristics of the pair of second capacitive loading elements 520A can be suppressed in comparison with the case where the parasitic element is provided. For this reason, the gain of an antenna including the pair of second capacitive loading elements 520A can be improved in comparison with a case where the parasitic element is provided.

In Embodiment 1, a direction of traveling wave of the first antenna element 410A and a direction of traveling wave of the second antenna element 420A are 90 degrees offset from each other in comparison with a case where both the first antenna element 410A and the second antenna element 420A are disposed along the longitudinal direction of the antenna base 100A as seen in the third direction Z. For this reason, deterioration of isolation between the first antenna element 410A and the second antenna element 420A at a high frequency band can be reduced in comparison with the above-described case.

In Embodiment 1, the height of the first antenna element 410A in the third direction Z is less than the height of the third antenna element 430A in the third direction Z. Accordingly, interference between the first antenna element 410A and the third antenna element 430A can be reduced and deterioration of isolation between the first antenna element 410A and the third antenna element 430A can be reduced in comparison with a case where the height of the first antenna element 410A in the third direction Z is equal to the height of the third antenna element 430A in the third direction Z. For this reason, the gain of each of the first antenna element 410A and the third antenna element 430A can be improved in comparison with the above-described case.

In Embodiment 1, the first antenna element 410A as a wall is present between the second antenna element 420A and the third antenna element 430A in comparison with a case where the first antenna element 410A is disposed along the longitudinal direction of the antenna base 100A as seen in the third direction Z. For this reason, deterioration of isolation between the second antenna element 420A and the third antenna element 430A can be reduced in comparison with the above-described case.

The pair of first capacitive loading elements 510A is electrically connected to the substrate 300A through an unillustrated coil element. The pair of first capacitive loading elements 510A and the coil element are an antenna to receive radio waves. The pair of first capacitive loading elements 510A and the coil element are, for example, Radio antennas. Each of the pair of first capacitive loading elements 510A and the coil element, however, may be at least one of a digital audio broadcast (DAB) antenna and a digital terrestrial television broadcasting (DTTB) antenna.

The pair of first capacitive loading elements 510A is arranged in the second direction Y. Specifically, the pair of first capacitive loading elements 510A is disposed on both a positive-direction side and a negative-direction side in the second direction Y with respect to an upper end portion of the second antenna element 420A. An upper rear portion of each of the first capacitive loading elements 510A is held by a holder and screwed above the substrate 300A via a connection metal fitting and is electrically connected to the substrate 300A.

Each first capacitive loading element 510A includes a meandering element section as seen in the second direction Y. Specifically, the meandering element section of each first capacitive loading element 510A is folded in the first direction X with a cutout extending in the first direction X. The length of the meandering element section of each first capacitive loading element 510A in the first direction X increases from an upper end of the first capacitive loading element 510A toward a lower end of the first capacitive loading element 510A along an inner surface of an upper portion of the antenna case 200A. Thus, the outline of each first capacitive loading element 510A in aggregate is approximately triangular as seen in the second direction Y. The characteristics of each first capacitive loading element 510A can be adjusted in accordance with parameters such as the length of the fold portion of the meandering element section in the first direction X, the width of the fold portion in the third direction Z, and the pitch of the fold portion in the third direction Z of each first capacitive loading element 510A. The shape of each first capacitive loading element 510A, however, is not limited to that in this example.

The pair of second capacitive loading elements 520A is electrically connected to the substrate 300A through the coil element 540A. The pair of second capacitive loading elements 520A and the coil element 540A is an antenna to receive radio waves. The pair of second capacitive loading elements 520A and the coil element 540A are, for example, DAB antennas. Each of the pair of second capacitive loading elements 520A and the coil element 540A, however, may be at least one of a Radio antenna and a DTTB antenna.

The pair of second capacitive loading elements 520A is arranged in the second direction Y. The pair of second capacitive loading elements 520A is disposed behind the pair of first capacitive loading elements 510A. A central portion of an upper end of each second capacitive loading element 520A in the first direction X is held by a holder and screwed above the substrate 300A via a connection metal fitting and is electrically connected to the substrate 300A. A front end of each second capacitive loading element 520A is spaced apart from a rear end of each first capacitive loading element 510A. Spacing the pair of first capacitive loading elements 510A and the pair of second capacitive loading elements 520A apart from each other in the first direction X enables the pair of first capacitive loading elements 510A and the pair of second capacitive loading elements 520A to operate as elements having different characteristics from each other. Spacing the pair of first capacitive loading elements 510A and the pair of second capacitive loading elements 520A apart from each other in the first direction X can make a space to dispose the first antenna element 410A between the pair of first capacitive loading elements 510A and the pair of second capacitive loading elements 520A as seen in the third direction Z.

Each second capacitive loading element 520A includes a meandering element section as seen in the second direction Y. Specifically, the meandering element section of each second capacitive loading element 520A is folded in the third direction Z with a cutout extending in the third direction Z. The outline of each second capacitive loading element 520A in aggregate is approximately quadrangular as seen in the second direction Y. The characteristics of each second capacitive loading element 520A can be adjusted in accordance with parameters such as the length of the fold portion of the meandering element section in the third direction z, the width of the fold portion in the first direction X, and the pitch of the fold portion in the first direction X of each second capacitive loading element 520A. The shape of each second capacitive loading element 520A, however, is not limited to that in this example.

In Embodiment 1, the first antenna element 410A is disposed between a region of the antenna base 100A that overlaps with the pair of first capacitive loading elements 510A in the third direction Z and a region of the antenna base 100A that overlaps with the pair of second capacitive loading elements 520A in the third direction Z as seen in the third direction Z. For this reason, interference between the first antenna element 410A and the pair of first capacitive loading elements 510A can be reduced and deterioration of isolation between the first antenna element 410A and the pair of first capacitive loading elements 510A can be reduced in Embodiment 1 in comparison with a case where the first antenna element 410A is disposed below the pair of first capacitive loading elements 510A. Accordingly, the gains of antennas including the pair of first capacitive loading elements 510A can be improved in comparison with the above-described case. Similarly, interference between the first antenna element 410A and the pair of second capacitive loading elements 520A can be reduced and deterioration of isolation between the first antenna element 410A and the pair of second capacitive loading elements 520A can be reduced in Embodiment 1 in comparison with a case where the first antenna element 410A is disposed below the pair of second capacitive loading elements 520A. Accordingly, the gain of an antenna including the pair of second capacitive loading elements 520A can be improved in comparison with the above-described case.

In Embodiment 1, the height of the first antenna element 410A in the third direction Z is less than the height of the pair of first capacitive loading elements 510A in the third direction Z. In Embodiment 1, the position of an upper end portion of the first antenna element 410A in the third direction Z is on a negative-direction side in the third direction Z with respect to the position of a lower end portion of each first capacitive loading element 510A in the third direction Z. In Embodiment 1, deterioration of isolation between the first antenna element 410A and the pair of first capacitive loading elements 510A can be reduced in comparison with a case where the height of the first antenna element 410A in the third direction Z is equal to or greater than the height of the pair of first capacitive loading elements 510A in the third direction Z.

Similarly, the height of the first antenna element 410A in the third direction Z is less than the height of the pair of second capacitive loading elements 520A in the third direction Z. In Embodiment 1, the position of the upper end portion of the first antenna element 410A in the third direction Z is on the negative-direction side in the third direction Z with respect to the position of a lower end portion of each second capacitive loading element 520A in the third direction Z. In Embodiment 1, deterioration of isolation between the first antenna element 410A and the pair of second capacitive loading elements 520A can be reduced in comparison with a case where the height of the first antenna element 410A in the third direction Z is equal to or greater than the height of the pair of second capacitive loading elements 520A in the third direction Z.

In Embodiment 1, a distance between the first antenna element 410A and the pair of first capacitive loading elements 510A and a distance between the first antenna element 410A and the pair of second capacitive loading elements 520A can be increased in comparison with a case where the first antenna element 410A is disposed along the longitudinal direction of the antenna base 100A as seen in the third direction Z. For this reason, isolation between the first antenna element 410A and the pair of first capacitive loading elements 510A and isolation between the first antenna element 410A and the pair of second capacitive loading elements 520A can be improved in Embodiment 1 in comparison with the above-described case.

The patch antenna 600A is, for example, at least one of a global navigation satellite system (GNSS) antenna and a satellite digital audio radio service (SDARS) antenna. As seen in the third direction Z, the patch antenna 600A has an approximately square shape. The shape of the patch antenna 600A, however, is not limited thereto. The patch antenna 600A is disposed on the upper surface side of the substrate 300A. As seen in the third direction 2, the patch antenna 600A is disposed in front of the second antenna element 420A and the pair of second capacitive loading elements 520A.

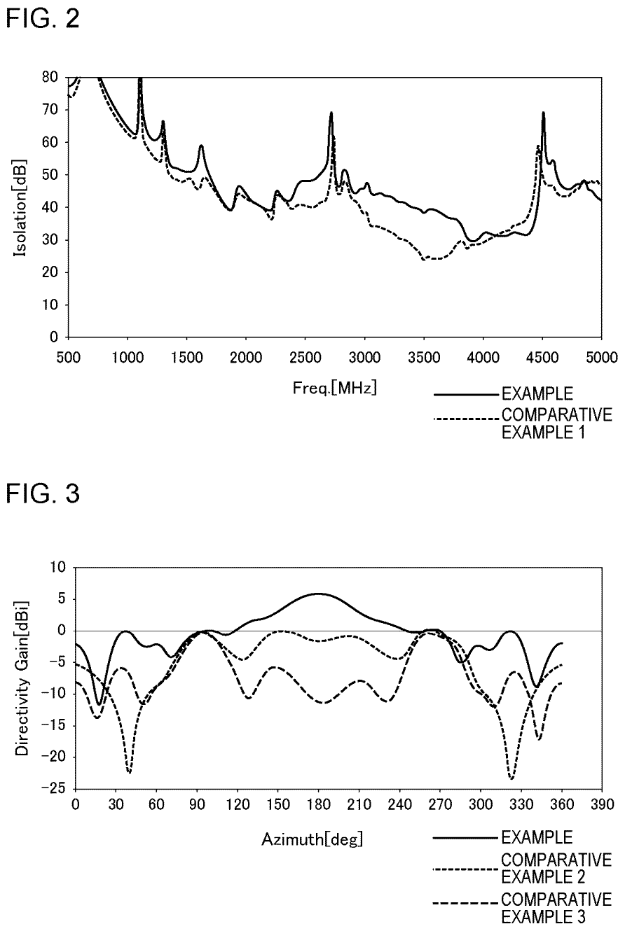

FIG. 2 is a graph showing the isolation value between a second antenna element and a third antenna element in an antenna device according to Example and the isolation value between a second antenna element and a third antenna element in an antenna device according to Comparative Example 1. The horizontal axis of the graph shown in FIG. 2 represents a frequency (unit: MHz). The vertical axis of the graph of FIG. 2 represents the isolation value (unit: dB).

The configuration of the antenna device according to Example was the same as the configuration of the antenna device 10A according to Embodiment 1. Specifically, a first antenna element was disposed along a direction perpendicular to a longitudinal direction of an antenna base as seen from above. The second antenna element was disposed in front of the first antenna element. The third antenna element was disposed behind the first antenna element.

The configuration of the antenna device according to Comparative Example 1 was the same as the configuration of the antenna device according to Example except that a first antenna element was disposed along a direction parallel to a longitudinal direction of an antenna base as seen from above.

As shown in FIG. 2, the isolation value of the antenna device according to Example was greater than the isolation value of the antenna device according to Comparative Example 1 almost throughout a frequency range of 500 MHZ to 5000 MHz. This result would reveal that the isolation value between the second antenna element and the third antenna element can be greater when the first antenna element is disposed along a direction intersecting the longitudinal direction of the antenna base than when the first antenna element is disposed along a longitudinal direction of the antenna base.

FIG. 3 is a graph showing a directivity gain with respect to an azimuth in the antenna device according to Example, a directivity gain with respect to an azimuth in an antenna device according to Comparative Example 2, and a directivity with respect to an azimuth in an antenna device according to Comparative Example 3. The horizontal axis of the graph shown in FIG. 3 represents an azimuth (unit: deg). The vertical axis of the graph shown in FIG. 3 represents a directivity gain (unit: dBi). An azimuth represented by the horizontal axis of the graph shown in FIG. 3 is an azimuth in the direction perpendicular to the third direction Z. As seen in the positive direction of the third direction z, the positive direction of the first direction X corresponds to an azimuth of 0 deg. An azimuth value increases as clockwise rotation from the positive direction of the first direction X progresses as seen in the positive direction of the third direction z.

The antenna device according to Comparative Example 2 was the same as the antenna device according to Example except that the first antenna element was not disposed and a screw as a reflector was disposed at a position where a first antenna was disposed in Example.

The antenna device according to Comparative Example 3 was the same as the antenna device according to Example except that the first antenna element was not disposed and a reflector was not disposed at a position where the first antenna was disposed in Example.

An azimuth range of 120 deg to 240 deg in the graph shown in FIG. 3 corresponds to a rear side of an antenna device. As shown in FIG. 3, a directivity gain at a rear side of the antenna device according to Example is greater than a directivity gain at a rear side of the antenna device according to Comparative Example 2 and a directivity gain at a rear side of the antenna device according to Comparative Example 3. This result would reveal that the first antenna base can operate as a reflector to reflect radio waves radiated from the third antenna element.

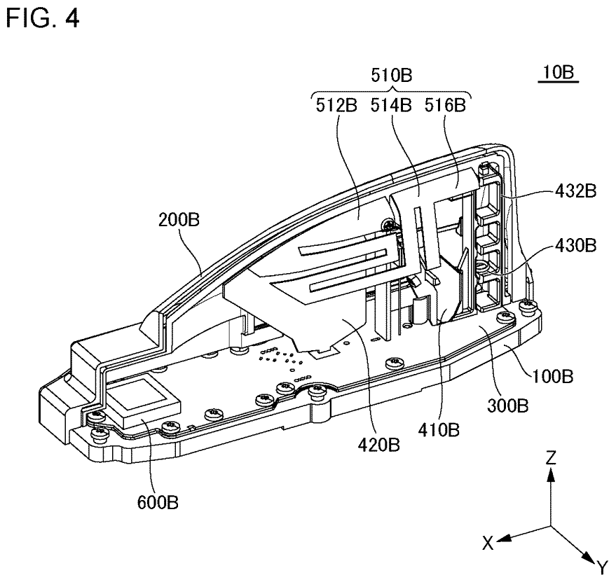

FIG. 4 is a perspective view of an antenna device 10B according to Embodiment 2. The antenna device 10B according to Embodiment 2 is the same as the antenna device 10A according to Embodiment 1 except for the following points.

The antenna device 10B according to Embodiment 2 includes an antenna base 100B, an antenna case 200B, a substrate 300B, a first antenna element 410B, a second antenna element 420B, a third antenna element 430B, an antenna holder 432B, capacitive loading elements 510B, and a patch antenna 600B. The capacitive loading elements 510B according to Embodiment 2 includes a first element section 512B, a second element section 514B, and a first protrusion 516B.

A pair of first capacitive loading elements 510B is arranged in the second direction Y. Specifically, the pair of first capacitive loading elements 510B is disposed on both a positive-direction side and a negative-direction side in the second direction Y with respect to an upper end portion of the second antenna element 420B. The capacitive loading elements 510B are electrically connected to the substrate 300B through an unillustrated coil element.

The first element section 512B is disposed on the positive-direction side in the second direction Y with respect to the upper end portion of the second antenna element 420B. The first element section 512B has a meandering shape as seen in the second direction Y. Specifically, the first element section 512B is folded in the first direction X with a cutout extending in the first direction X. An upper rear portion of the first element section 512B is held by a holder and screwed above the substrate 300B through a connection metal fitting and is electrically connected to the substrate 300B.

The second element section 514B has a meandering shape as seen in the second direction Y. Specifically, the second element section 514B is folded in the third direction Z with a cutout extending in the third direction Z. A front end portion of a lower end of the second element section 514B is connected to a rear end portion of a lower end of the first element section 512B. Thus, the first element section 512B and the second element section 514B are integrated with each other.

The first protrusion 516B protrudes rearward from a rear end portion of an upper end of the second element section 514B. The first protrusion 516B is integrated with the second element section 514B. In Embodiment 2, the area of the capacitive loading element 510B as seen in the second direction Y can be increased in comparison with a case where the first protrusion 516B is not provided. For this reason, the gain of an antenna including the capacitive loading elements 510B can be increased in Embodiment 2 in comparison with the above-described case. In Embodiment 2, stray capacitance between the capacitive loading elements 510B and the third antenna element 430B can be reduced in comparison with a case where a rear end portion of the second element section 514B protrudes rearward throughout an area from the lower end of the second element section 514B to the upper end of the second element section 514B instead of the first protrusion 516B. For this reason, the gain of an antenna including the capacitive loading elements 510B can be increased in Embodiment 2 in comparison with the above-described case.

The structures and the arrangement of the first antenna element 410B, the second antenna element 420B, and the third antenna element 430B according to Embodiment 2 are the same as the structures and the arrangement of the first antenna element 410A, the second antenna element 420A, and the third antenna element 430A according to Embodiment 1 except that a distance in the first direction X between the first antenna element 410B and the third antenna element 430B according to Embodiment 2 is less than a distance in the first direction X between the first antenna element 410A and the third antenna element 430A according to Embodiment 1.

In Embodiment 2, the size of the antenna device 10B in the first direction X can be reduced in comparison with a case where the first antenna element 410B is disposed along a longitudinal direction of the antenna base 100B as seen in the third direction z.

In Embodiment 2, the length of the space necessary between the first antenna element 410B and the second antenna element 420B in the first direction X can be reduced in comparison with a case where the first antenna element 410B and the second antenna element 420B are disposed along the longitudinal direction of the antenna base 100B as seen in the third direction Z. For this reason, deterioration of isolation between the first antenna element 410B and the second antenna element 420B can be reduced in comparison with the above-described case even if the length of the antenna device 10B in the first direction X is decreased.

In Embodiment 2, the length of the space necessary between the first antenna element 410B and the third antenna element 430B in the first direction X can be reduced in comparison with a case where the first antenna element 410B is disposed along the longitudinal direction of the antenna base 100B as seen in the third direction Z. For this reason, deterioration of isolation between the first antenna element 410B and the third antenna element 430B can be reduced in comparison with the above-described case even if the length of the antenna device 10B in the first direction X is decreased.

In Embodiment 2, deterioration of isolation between the first antenna element 410B and the second antenna element 420B can be reduced in comparison with a case where the height of the first antenna element 410B in the third direction Z is equal to the height of the second antenna element 420B in the third direction Z. Similarly, isolation between the first antenna element 410B and the third antenna element 430B can be secured in comparison with a case where the height of the first antenna element 410B in the third direction Z is equal to the height of the third antenna element 430B in the third direction Z.

In Embodiment 2, the first antenna element 410B can operate as a reflector for radio waves radiated from the third antenna element 430B in comparison with a case where the first antenna element 410B is not provided or a case where the first antenna element 410B is disposed along the longitudinal direction of the antenna base 100B as seen in the third direction Z. For this reason, the rearward directivity of the third antenna element 430B can be improved in comparison with the above-described case.

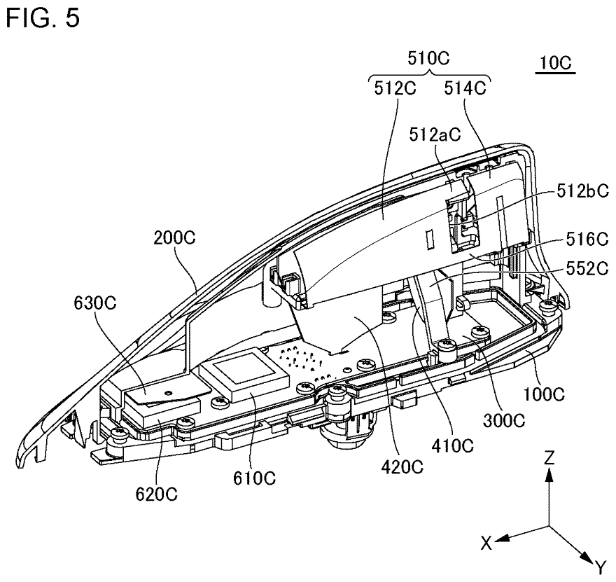

FIG. 5 is a perspective view of an antenna device 10C according to Embodiment 3. The antenna device 10C according to Embodiment 3 is the same as the antenna device 10A according to Embodiment 1 except for the following points.

The antenna device 10C includes an antenna base 100C, an antenna case 200C, a substrate 300C, a first antenna element 410C, a second antenna element 420C, capacitive loading elements 510C, a first patch antenna 610C, a second patch antenna 620C, and a front parasitic element 630C. The capacitive loading elements 510C according to Embodiment 3 includes a first element section 512C and a second element section 514C.

A pair of the capacitive loading elements 510C is arranged in the second direction Y. Specifically, the pair of capacitive loading elements 510C is disposed on both the positive-direction side and the negative-direction side in the second direction Y with respect to an upper end portion of the second antenna element 420C. The capacitive loading elements 510C are electrically connected to the substrate 300C through an unillustrated coil element.

The first element section 512C is disposed on the positive-direction side in the second direction Y with respect to the upper end portion of the second antenna element 420C. The first element section 512C has a plate-like shape as seen in the second direction Y. A second protrusion 512aC is provided at a rear end portion of an upper end of the first element section 512C. An attachment portion 512bC is provided on a negative-direction side in the third direction Z and on a negative-direction side in the second direction Y with respect to the second protrusion 512aC. The attachment portion 512bC is provided with a through hole for screwing the first element section 512C to an unillustrated upper holder provided above a lower holder 552C.

The second element section 514C is disposed behind the first element section 512C. The second element section 514C has a plate-like shape as seen in the second direction Y. A front end portion of a lower end of the second element section 514C is connected to a rear end portion of a lower end of the first element section 512C through a connection portion 516C. Thus, the first element section 512C and the second element section 514C are integrated with each other through the connection portion 516C. A front end portion of the second element section 514C is spaced apart from a rear end portion of the first element section 512C with a gap interposed therebetween except at the connection portion 516C. Thus, the electrical length of the entire capacitive loading element 510C is adjusted.

The second patch antenna 620C is disposed in front of the first patch antenna 610C. The front parasitic element 630C, spaced apart from an upper surface of the second patch antenna 620C, covers the second patch antenna 620C. The gain of the second patch antenna 620C in a direction toward the zenith, which is on a positive-direction side in the third direction Z, can be greater when the front parasitic element 630C covers the second patch antenna 620C than when the front parasitic element 630C is not provided.

The structures and the arrangement of the first antenna element 410C and the second antenna element 420C according to Embodiment 3 are the same as the structures and the arrangement of the first antenna element 410A and the second antenna element 420A according to Embodiment 1. In Embodiment 3, however, an antenna element corresponding to the third antenna element 430A according to Embodiment 1 is not provided.

In Embodiment 3, the size of the antenna device 10C in the first direction X can be reduced in comparison with a case where the first antenna element 410C is disposed along a longitudinal direction of the antenna base 100C as seen in the third direction z.

In Embodiment 3, the length of the space necessary between the first antenna element 410C and the second antenna element 420C in the first direction X can be reduced in comparison with a case where the first antenna element 410C and the second antenna element 420C are disposed along the longitudinal direction of the antenna base 100C as seen in the third direction Z. For this reason, deterioration of isolation between the first antenna element 410C and the second antenna element 420C can be reduced in comparison with the above-described case even if the length of the antenna device 10C in the first direction X is decreased.

In Embodiment 3, deterioration of isolation between the first antenna element 410C and the second antenna element 420C can be reduced in comparison with a case where the height of the first antenna element 410C in the third direction Z is equal to the height of the second antenna element 420C in the third direction z.

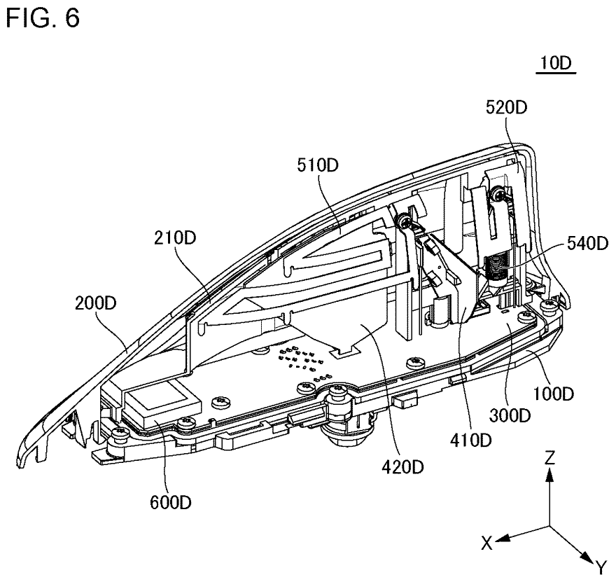

FIG. 6 is a perspective view of an antenna device 10D according to Embodiment 4. The antenna device 10D according to Embodiment 4 is the same as the antenna device 10A according to Embodiment 1 except for the following points.

The antenna device 10D according to Embodiment 4 includes an antenna base 100D, an antenna case 200D, an inner case 210D, a substrate 300D, a first antenna element 410D, a second antenna element 420D, a first capacitive loading element 510D, a second capacitive loading element 520D, a coil element 540D, and a patch antenna 600D.

The inner case 210D covers the antenna base 100D from above. The inner case 210D forms an accommodation space together with the antenna base 100D. The accommodation space accommodates the substrate 300D, the first antenna element 410D, the second antenna element 420D, the first capacitive loading element 510D, the second capacitive loading element 520D, the coil element 540D, and the patch antenna 600D. The antenna case 200D covers the antenna base 100D and the inner case 210D from above. The antenna case 200D forms an accommodation space to accommodate the inner case 210D.

The structures and the arrangement of the first antenna element 410D, the second antenna element 420D, the first capacitive loading element 510D, the second capacitive loading element 520D, and the coil element 540D according to Embodiment 4 are the same as the structures and the arrangement of the first antenna element 410A, the second antenna element 420A, the first capacitive loading element 510A, the second capacitive loading element 520A, and the coil element 540A according to Embodiment 1. In Embodiment 4, however, an antenna element corresponding to the third antenna element 430A according to Embodiment 1 is not provided.

In Embodiment 4, the size of the antenna device 10D in the first direction X can be reduced in comparison with a case where the first antenna element 410D is disposed along a longitudinal direction of the antenna base 100D as seen in the third direction Z.

In Embodiment 4, the length of the space necessary between the first antenna element 410D and the second antenna element 420D in the first direction X can be reduced in comparison with a case where the first antenna element 410D and the second antenna element 420D are disposed along the longitudinal direction of the antenna base 100D as seen in the third direction Z. For this reason, deterioration of isolation between the first antenna element 410D and the second antenna element 420D can be reduced in comparison with the above-described case even if the length of the antenna device 10D in the first direction X is decreased.

In Embodiment 4, deterioration of isolation between the first antenna element 410D and the second antenna element 420D can be reduced in comparison with a case where the height of the first antenna element 410D in the third direction Z is equal to the height of the second antenna element 420D in the third direction Z.

In Embodiment 4, deterioration of isolation between the first antenna element 410D and the first capacitive loading element 510D can be reduced in comparison with a case where the first antenna element 410D is disposed below the first capacitive loading element 510D. Similarly, in Embodiment 4, deterioration of isolation between the first antenna element 410D and the second capacitive loading element 520D can be reduced in comparison with a case where the first antenna element 410D is disposed below the second capacitive loading element 520D.

In Embodiment 4, a distance between the first antenna element 410D and the first capacitive loading element 510D and a distance between the first antenna element 410D and the second capacitive loading element 520D can be increased in comparison with a case where the first antenna element 410D is disposed along the longitudinal direction of the antenna base 100D as seen in the third direction Z. For this reason, isolation between the first antenna element 410D and the first capacitive loading element 510D and isolation between the first antenna element 410D and the second capacitive loading element 520D can be improved in Embodiment 4 in comparison with the above-described case.

In Embodiment 4, deterioration of isolation between the first antenna element 410D and the first capacitive loading element 510D can be reduced in comparison with a case where the height of the first antenna element 410D in the third direction Z is equal to or greater than the height of the first capacitive loading element 510D in the third direction Z. Similarly, in Embodiment 4, deterioration of isolation between the first antenna element 410D and the second capacitive loading element 520D can be reduced in comparison with a case where the height of the first antenna element 410D in the third direction z is equal to or greater than the height of the second capacitive loading element 520D in the third direction Z.

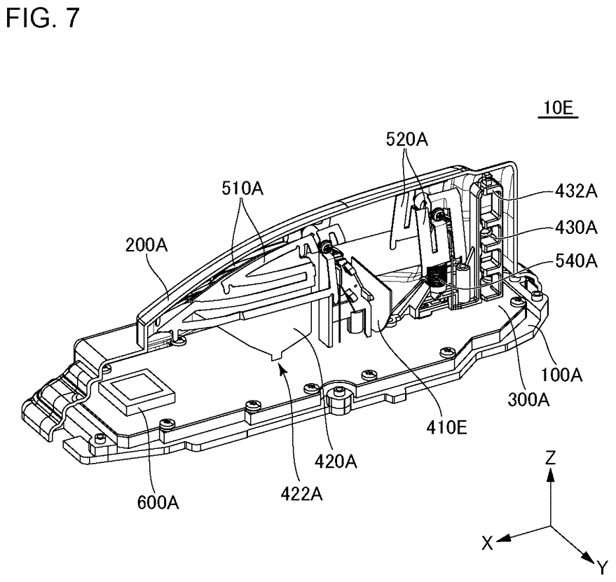

FIG. 7 is a perspective view of an antenna device 10E according to a variant. The antenna device 10E according to the variant is the same as the antenna device 10A according to Embodiment 1 except that a first parasitic element 410E is provided instead of the first antenna element 410A.

The first parasitic element 410E according to the variant has the same structure as the first antenna element 410A according to Embodiment 1 except that no feeding point is provided. The arrangement of the first parasitic element 410E, the second antenna element 420A, and the third antenna element 430A according to the variant is the same as the arrangement of the first antenna element 410A, the second antenna element 420A, and the third antenna element 430A according to Embodiment 1.

In the variant, the size of the antenna device 10E in the first direction X can be reduced in comparison with a case where the first parasitic element 410E is disposed along a longitudinal direction of the antenna base 100A as seen in the third direction Z.

In the variant, the length of the space necessary between the first parasitic element 410E and the second antenna element 420A in the first direction X can be reduced in comparison with a case where the first parasitic element 410E and the second antenna element 420A are disposed along the longitudinal direction of the antenna base 100A as seen in the third direction Z. For this reason, deterioration of isolation between the first parasitic element 410E and the second antenna element 420A can be reduced in comparison with the above-described case even if the length of the antenna device 10D in the first direction X is decreased.

In the variant, the length of the space necessary between the first parasitic element 410E and the third antenna element 430A in the first direction X to secure isolation between the first parasitic element 410E and the third antenna element 430A can be reduced in comparison with a case where the first parasitic element 410E is disposed along the longitudinal direction of the antenna base 100A as seen in the third direction Z.

In the variant, deterioration of isolation between the first parasitic element 410E and the second antenna element 420A can be reduced in comparison with a case where the height of the first parasitic element 410E in the third direction Z is equal to the height of the second antenna element 420A in the third direction Z. Similarly, deterioration of isolation between the first parasitic element 410E and the third antenna element 430A can be reduced in comparison with a case where the height of the first antenna element 410A in the third direction Z is equal to the height of the third antenna element 430A in the third direction Z.

In the variant, the first parasitic element 410E can operate as a reflector for radio waves radiated from the third antenna element 430A in comparison with a case where the first parasitic element 410E is not provided or a case where the first parasitic element 410E is disposed along the longitudinal direction of the antenna base 100A as seen in the third direction Z. For this reason, the rearward directivity of the third antenna element 430A can be improved in comparison with a case where the first parasitic element 410E is not provided or a case where the first parasitic element 410E is disposed along the longitudinal direction of the antenna base 100A as seen in the third direction Z.

In the variant, deterioration of isolation between the first parasitic element 410E and the pair of first capacitive loading elements 510A can be reduced in comparison with a case where the first parasitic element 410E is disposed below the pair of first capacitive loading elements 510A. Similarly, in the variant, deterioration of isolation between the first parasitic element 410E and the pair of second capacitive loading elements 520A can be reduced in comparison with a case where the first parasitic element 410E is disposed below the pair of second capacitive loading elements 520A.

In the variant, a distance between the first parasitic element 410E and the pair of first capacitive loading elements 510A and a distance between the first parasitic element 410E and the pair of second capacitive loading elements 520A can be increased in comparison with a case where the first parasitic element 410E is disposed along the longitudinal direction of the antenna base 100A as seen in the third direction Z. For this reason, deterioration of the isolation between the first parasitic element 410E and the pair of first capacitive loading elements 510A and deterioration of isolation between the first parasitic element 410E and the pair of second capacitive loading elements 520A can be reduced in the variant in comparison with the above-described case.

In the variant, deterioration of isolation between the first parasitic element 410E and the pair of first capacitive loading elements 510A can be reduced in comparison with a case where the height of the first parasitic element 410E in the third direction Z is equal to or greater than the height of the pair of first capacitive loading elements 510A in the third direction Z. Similarly, in the variant, deterioration of isolation between the first parasitic element 410E and the pair of second capacitive loading elements 520A can be reduced in comparison with a case where the height of the first parasitic element 410E in the third direction Z is equal to or greater than the height of the pair of second capacitive loading elements 520A in the third direction z.

Although the embodiments and variants of the present invention have been described with reference to drawings, these are mere examples of the present invention, and various other configurations other than those given above may be adopted.

According to the present specification, the following aspects are provided.

### (Aspect 1)

Aspect 1 is an antenna device comprising
an antenna base,
an antenna case forming an accommodation space together with the antenna base, and
a first antenna element accommodated in the accommodation space,
in which the first antenna element is disposed along a direction intersecting a longitudinal direction of the antenna base.

According to Aspect 1, the length of the first antenna element in the longitudinal direction can be decreased in comparison with a case where the first antenna element is disposed along the longitudinal direction. For this reason, the size of the antenna device can be reduced in comparison with a case where the first antenna element is disposed along the longitudinal direction.

### (Aspect 2)

Aspect 2 is the antenna device described in Aspect 1 further comprising
a second antenna element disposed on one side in the longitudinal direction with respect to the first antenna element,
in which the second antenna element is disposed along the longitudinal direction.

According to Aspect 2, a length of a space necessary between the first antenna element and the second antenna element in the longitudinal direction can be reduced in comparison with a case where both the first antenna element and the second antenna element are disposed along the longitudinal direction. For this reason, deterioration of isolation between the first antenna element and the second antenna element can be reduced in comparison with the above-described case even if the length of the antenna device in the longitudinal direction is decreased.

### (Aspect 3)

Aspect 3 is the antenna device described in Aspect 2 further comprising
a third antenna element disposed on the other side in the longitudinal direction with respect to the first antenna element,
in which a height of the first antenna element is less than at least one of a height of the second antenna element and a height of the third antenna element.

According to Aspect 3, interference between the first antenna element and the second antenna element can be reduced and deterioration of isolation between the first antenna element and the second antenna element can be reduced in comparison with a case where the height of the first antenna element is equal to the height of the second antenna element. Similarly, interference between the first antenna element and the third antenna element and deterioration of isolation between the first antenna element and the third antenna element can be reduced in comparison with a case where the height of the first antenna element is equal to the height of the third antenna element.

### (Aspect 4)

Aspect 4 is the antenna device described in any one of Aspects 1 to 3, further comprising
two capacitive loading elements overlapping with the antenna base,
in which the first antenna element is disposed between regions of the antenna base overlapping with the two capacitive loading elements.

According to Aspect 4, interference between the first antenna element and the two capacitive loading elements can be reduced and deterioration of isolation between the first antenna element and the two first capacitive loading elements can be reduced in comparison with a case where the first antenna element overlaps with the two capacitive loading elements.

### (Aspect 5)

Aspect 5 is the antenna device described in Aspect 4,
in which a height of the first antenna element is less than a height of at least one of the two capacitive loading elements.

According to Aspect 5, deterioration of isolation between the first antenna element and at least one of the two capacitive loading elements can be reduced in comparison with a case where the height of the first antenna element is equal to or greater than the height of at least one of the two capacitive loading elements.

### (Aspect 6)

Aspect 6 is the antenna device described in any one of Aspects 1 to 5,
in which the first antenna element includes a portion to operate as a self-similar antenna or an antenna equivalent to the self-similar antenna.

According to Aspect 6, the first antenna element can operate in wideband and can be suitable for a TEL antenna.

### (Aspect 7)

Aspect 7 is the antenna device described in any one of Aspects 1 to 6,
in which the first antenna element operates as a reflector of another antenna accommodated in the accommodation space.

According to Aspect 7, the directivity of the other antenna in a desired direction can be improved in comparison with a case where the first antenna element does not operate as the reflector.

### (Aspect 8)

Aspect 8 is the antenna device described in Aspect 1, further comprising at least one of a second antenna element disposed on one side in the longitudinal direction with respect to the first antenna element, and a third antenna element disposed on the other side in the longitudinal direction with respect to the first antenna element.

According to Aspect 8, MIMO can be realized by using at least one of the second antenna element and the third antenna element together with the first antenna element.

### (Aspect 9)

Aspect 9 is the antenna device described in Aspect 3,
in which the third antenna element is a V2X antenna.

According to Aspect 9, the first antenna element can operate as a reflector to reflect radio waves radiated from the third antenna element. In Aspect 9, there is a case where a relatively strong directivity in a predetermined direction is required for the third antenna element. In this case, a directivity toward a side opposite to a side on which the first antenna element is disposed with respect to the third antenna element can be enhanced according to Aspect 9 in comparison with a case where the first antenna element is not provided or a case where the first antenna element is disposed along the longitudinal direction of the antenna base.

### (Aspect 10)

Aspect 10 is the antenna device described in any one of Aspects 1 to 9,
in which the first antenna element is at least one of a TEL antenna, a Wi-Fi (registered trademark) antenna, a Bluetooth (registered trademark) antenna, a V2X antenna, and a keyless entry antenna.

According to Aspect 10, the size of the antenna device in the longitudinal direction of the antenna base can be reduced like Aspect 1 in comparison with a case where the first antenna element is disposed along the longitudinal direction of the antenna base.

This application claims priority based on Japanese Patent Application No. 2022-11482 filed on Jan. 28, 2022, the entire content of which is incorporated herein by reference.

### REFERENCE SIGNS LIST

10A, 10B, 10C, 10D, 10E antenna device, 100A, 100B, 100C, 100D antenna base, 200A, 200B, 200C, 200D antenna case, 210D inner case, 300A, 300B, 300C, 300D substrate, 410A, 410B, 410C, 410D first antenna element, 410E first parasitic element, 412A first base end portion, 420A, 420B, 420C, 420D second antenna element, 422A second base end portion, 430A, 430B third antenna element, 432A, 432B antenna holder, 510A, 510B, 510C, 510D first capacitive loading element, 512B, 512C first element section, 512aC second protrusion, 512bC attachment portion, 514B, 514C second element section, 516B first protrusion, 516C connection portion, 520A, 520D second capacitive loading element, 540A, 540D coil element, 552C lower holder, 600A, 600B, 600D patch antenna, 610C first patch antenna, 620C second patch antenna, 630C front parasitic element, X first direction, Y second direction, Z third direction

1. An antenna device comprising:
an antenna base;
an antenna case forming an accommodation space together with the antenna base; and
a first antenna element accommodated in the accommodation space,
wherein the first antenna element is disposed along a direction intersecting a longitudinal direction of the antenna base.

2. The antenna device according to claim 1, further comprising:
a second antenna element disposed on one side in the longitudinal direction with respect to the first antenna element,
wherein the second antenna element is disposed along the longitudinal direction.

3. The antenna device according to claim 2, further comprising:
a third antenna element disposed on the other side in the longitudinal direction with respect to the first antenna element,
wherein a height of the first antenna element is less than at least one of a height of the second antenna element and a height of the third antenna element.

4. The antenna device according to claim 1, further comprising:
two capacitive loading elements overlapping with the antenna base,
wherein the first antenna element is disposed between regions of the antenna base overlapping with the two capacitive loading elements.

5. The antenna device according to claim 4,
wherein a height of the first antenna element is less than a height of at least one of the two capacitive loading elements.

6. The antenna device according to claim 1,
wherein the first antenna element includes a portion to operate as a self-similar antenna or an antenna equivalent to the self-similar antenna.

7. The antenna device according to claim 1,
wherein the first antenna element operates as a reflector of another antenna accommodated in the accommodation space.
